(19) United States
(12) Patent Application Publication
(10) Pub. No.: US 2025/0257531 A1
(43) Pub. Date: Aug. 14, 2025

(54) Advanced Vehicular Signage for Enhanced Data Communication

(71) Applicant: Vincent Loccisano

(72) Inventor: Vincent Loccisano

(21) Appl. No.: 18/441,613

(22) Filed: Feb. 14, 2024

(51) Int. Cl. E01F 9/30; B60W 60/00; E01F 9/512; E01F 9/576; G06K 7/14

(52) U.S. Cl. CPC E01F 9/30; B60W 60/001; E01F 9/512; E01F 9/576; G06K 7/1413; G06K 7/1417; B60W 2420/403; B60W 2555/60

(57) ABSTRACT

A system and method in which road markings, such as center-lane, shoulder markings and vertically oriented sign markings, are surface coatings configured to transmit machine-readable data to electronic equipment on self-driving or driving-assisted vehicles. In an embodiment, painted markings create a type of matrix code or barcode that can be read by optical detection systems in a vehicle. The data is used to inform active safety systems about road conditions, obstacles, grades, speed limits, turns, HOV, EV, or autonomous lane options, as well as other data, to safely conduct autonomous and semi-autonomous vehicles. In some embodiments markings are applied with coatings that are readable by electronic components and cameras onboard a vehicle, and may not be visible to humans.

### TECHNICAL FIELD

The present disclosure relates to enhanced road-marking systems that are machine-readable to provide data to autonomous and semi-autonomous vehicles. The disclosure relates also to a method of applying roadway markers and signage to render them easily discerned by onboard cameras that work with automatic vehicle-safety systems.

### BACKGROUND OF THE INVENTION

Semi- and fully autonomous vehicles use on-board cameras and sensors to detect and process man-made road markings to safely guide the vehicle and transmit information to another location. Current roadway marking systems use painted stripes, thermoplastic markers with reflective properties, embedded reflectors, magnetic markers, and active, signal-transmitting systems for lane delineation and information. Laser radars detect reflective markings translated by control mechanisms in the vehicle to guide steering, acceleration and braking. Active safety systems (collision-warning, automatic emergency-braking, collision-intervention) warn and automatically correct autonomous and semi-autonomous vehicles.

Systems that rely on capturing visual markers can be compromised when these markers are obscured by snow, rain, road debris or obstacles. A simple, coded roadway-marking system that stores and transmits data without the use of conventional visual markers can overcome this limitation.

### SUMMARY OF THE INVENTION

A system and method in which road markings, such as center-lane and shoulder markings and vertically oriented sign markings, are surface coatings configured to transmit machine-readable data to electronic equipment on self-driving or driving-assisted vehicles. Electronic equipment includes cameras, sensors, processors, and the like that convert information derived from machine-readable data to assist in the control of a vehicle. In an embodiment, road markings are painted in a pattern to make a type of matrix code or barcode that can be read by optical detection systems in a vehicle. The data is used to inform active safety systems about road conditions, obstacles, grades, speed limits, turns, HOV, EV, or autonomous-lane options, and distances between vehicles, braking-points, and other data, to safely conduct autonomous and semi-autonomous vehicles.

In some embodiments, markings are applied with coatings that are readable by electronic components and cameras onboard a vehicle, and may not be visible to humans. In some embodiments a non-visible (e.g., ultraviolet (UV)) paint is used. One skilled in the art is familiar with coatings readable by electronic equipment that may produce an image that remains outside of the human visible spectrum. A coating may be applied to transparent road-surface material with adhesive. Optionally, a coating may simply optically transmit information, for example the way a streetlamp projects light.

Signs not visible to humans may be placed on a road, existing sign, architecture, signpost or any surface in proximity of traffic, close enough for an onboard vehicle camera to read. The onboard camera reads the matrix code/barcode and, as in the above embodiment, informs the vehicle's active safety system accordingly. The onboard camera can be sensitized to UV paint, resulting in a clearer discernment of road markings than non-UV markings, especially in low-visibility conditions.

In an example embodiment, a matrix code or barcode is applied to vertical surfaces, road surfaces, and atop road-line markings to provide sufficient information for a vehicle's onboard camera and processor. A barcode in this embodiment would use a check digit, which is the final digit of a fixed-length, numeric GS1 identification key, to ensure the integrity of the key. Matrix-code information can be understood by a processor (on a vehicle or offsite) to generate virtual road-marking lines on a projected image such as a “heads-up display” that is visible to a driver. (One skilled in the art is familiar with “heads-up displays,” informational tools that project images onto a vehicle's windshield.) In this example embodiment, the virtual road marking may be more accurate than visible markings and may be readable despite road conditions.

The coded markings are applied to roadways using automated paint sprayers known in the art. Such a system can be easily adopted and interoperable with existing marking and signaling systems and methods. These coded markings can be applied during the roadway-building process, or retrofitted into a roadway.

A coded system could be employed anywhere in or around the roadway. It may be embedded in the pavement concrete during construction, or may replace roadside directional signs, eventually obviating the need for existing road signs.

These embodiments are applicable in rail transit, and can be employed in developing technologies like tube transit.

### BRIEF DESCRIPTION OF DRAWINGS

FIG. 1 is an illustration of an example of the embodiment on a road sign.

FIG. 2 is an illustration of an example of the embodiment on a road-line marking.

### DETAILED DESCRIPTION

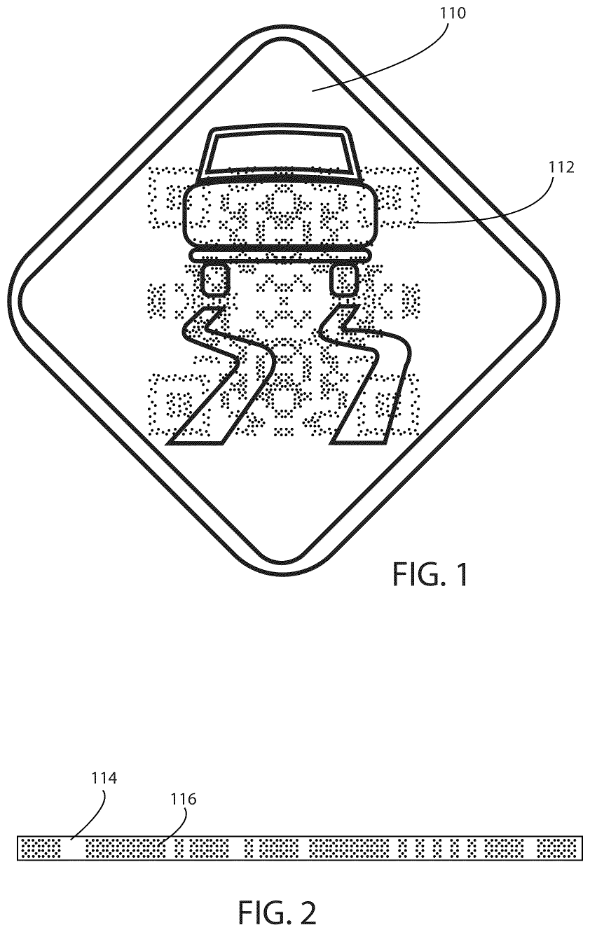

FIG. 1 shows an illustration of a road sign 110 with a QR code 112 applied over the road sign 110 in a coating that is readable by electronic equipment. The QR code 112 is shown in pixelated format to demonstrate that it is in a spectrum not necessarily visible to the human eye.

FIG. 2 shows an illustration of a road-line segment 114 with a barcode 116 applied over the line marking in a coating that is readable by electronic equipment. The barcode 116 is shown in pixelated format to demonstrate that it is in a spectrum not necessarily visible to the human eye.

1. An apparatus for road signage, the apparatus comprising:
a coating that is readable by electronic equipment configured to apply to a surface;
and said coating, on a surface in view of a vehicle receiver, is readable by a processor electronically coupled to said receiver; wherein
said coating transmits roadway-specific data for use by a vehicle operating on said roadways

2. The apparatus of claim 1 wherein:
said coating is visible to the human eye.

3. The apparatus of claim 1 wherein:
said coating is invisible to the human eye

4. The apparatus of claim 1 wherein:
said coating includes traditional roadway markings known to vehicle operators.

5. The apparatus of claim 1 wherein:
said surface is a pre-existing component of conventional road signage.

6. The apparatus of claim 1 wherein:
said surface is conventional road markings that are applied as segments that make a matrix code.

7. The apparatus of claim 1 wherein:
coating is applied as part of the roadway-building process.

8. The apparatus of claim 1 wherein:
said coating is applied after the roadway is completed.

9. The apparatus of claim 1 wherein:
said surface is a conventional road.

10. The apparatus of claim 1 wherein:
said coating is applied as part of the roadway-building process.

11. The apparatus of claim 1 wherein:
said coating is utilized by fully autonomous vehicles.

12. The apparatus of claim 1 wherein:
said roadway-specific data includes speed, grade, vehicular spacing, braking points and speed-zone changes.

13. The apparatus of claim 1 wherein:
said data is in the form of a matrix code.

14. The apparatus of claim 1 wherein:
said data may be repeated along a length of roadway.

15. An apparatus for road signage, the apparatus comprising:
a projector configured to project an image onto a roadway surface; and
said surface is in view of a vehicle receiver, is readable by a processor electronically coupled to said receiver; wherein
said image transmits roadway-specific data for use by a vehicle operating on said roadways

16. A method for providing information to vehicle self-driving equipment, the method comprising:
providing a coating that is readable by electronic visualization equipment: and applying information readable by said electronic visualization equipment to a surface: and
capturing an image of said readable coating with said electronic visualization equipment; and
transmitting said information to a processor: wherein
information transmitted to said processor is used by vehicle self-driving equipment to assist in conducting said vehicle.

17. The method of claim 16 wherein:
said coating is visible to the human eye.

18. The method of claim 16 wherein:
said coating is invisible to the human eye.

19. The method of claim 16 further comprising:
applying information readable by said electronic visualization equipment to components of conventional road signage.

20. The method of claim 16 further comprising:
applying said coating in the form of machine-readable information to a transparent surface material; and
applying adhesive to one side of said transparent surface material: and applying said transparent surface material and coating to a surface.
